(19) United States
(12) Patent Application Publication
(10) Pub. No.: US 2026/0207028 A1
(43) Pub. Date: Jul. 23, 2026

(54) ROTARY MOP CLEANING TOOL

(71) Applicant: CIXI BOSHENG PLASTIC CO., LTD., Cixi (CN)

(72) Inventor: Zhenghui HUANG, Cixi (CN)

(73) Assignee: CIXI BOSHENG PLASTIC CO., LTD., Cixi (CN)

(21) Appl. No.: 19/026,512

(22) Filed: Jan. 17, 2025

(51) Int. Cl. A47L 13/502; A47L 13/255; B25G 1/04

(52) U.S. Cl. CPC A47L 13/502; A47L 13/255; B25G 1/04

(57) ABSTRACT

A rotary mop cleaning tool includes a mop and a mop bucket, where an upper part of the mop bucket is provided with a rotatable spin drying basket; the mop includes a mop head, as well as an upper rod and a lower rod that are joined together; a bottom surface of the spin drying basket is provided with a projection; when the cleaning strings on the mop head are spin-dried, the rotation center of the mop head is in contact with the projection, thereby forming a constraining space between the base plate of the mop head and the spin drying basket; and when the mop head is placed in the spin drying basket, the mop head is connected in a driving manner to the projection of the spin drying basket, such that the spin drying basket is driven by the rotating mop head to rotate.

### TECHNICAL FIELD

The present disclosure relates to a rotary mop cleaning tool.

### BACKGROUND

Patent applications CN201438956U, EP06724523A, and CN101828893A each disclose a rotary mop cleaning tool. The rotary mop cleaning tool includes a mop and a mop bucket. The upper part of the mop bucket is provided with a rotatable spin drying basket. The mop includes a mop head, as well as an upper rod and a lower rod that are joined together. The back surface of the mop head is provided with cleaning strings. The lower end of the lower rod is connected to a rotation center of the mop head. A driving mechanism is provided between the upper rod and the lower rod. When the cleaning strings on the mop head are spin-dried, the mop head is placed in the spin drying basket, such that the cleaning strings are constrained within the spin drying basket, and then the upper rod is pressed downward relative to the lower rod. When the upper rod is pressed downward, the driving mechanism drives the lower rod to rotate, thereby driving the mop head at the lower end of the lower rod to rotate. In this way, the cleaning strings on the mop head undergo high-speed centrifugal rotation, achieving the effect of a high-speed centrifugal spin drying.

When the cleaning strings are constrained within the spin drying basket for spin drying, the mop head is pressed tightly in the spin drying basket. The spin drying basket provides support for the mop head to smoothly rotate at high speed. However, because the cleaning strings are pressed tightly in the spin drying basket, it is hard to shake off water in the cleaning strings and shake off dirt contained in the water and adhered to the cleaning strings.

### SUMMARY

In order to overcome the above-mentioned shortcoming of the existing rotary mop cleaning tool, the present disclosure provides a rotary mop cleaning tool with better spin drying and dirt removing effects.

In order to solve the above technical problem, the present disclosure adopts the following technical solution. A rotary mop cleaning tool includes a mop and a mop bucket, where

an upper part of the mop bucket is provided with a rotatable spin drying basket;

the mop includes a mop head, as well as an upper rod and a lower rod that are joined together; the mop head includes a base plate and cleaning strings provided on the base plate; the cleaning strings protrude from a back surface of the base plate; a lower end of the lower rod is connected to a rotation center of the mop head; and a driving mechanism is provided between the upper rod and the lower rod;

when the cleaning strings on the mop head are spin-dried, the mop head is placed in the spin drying basket, such that the cleaning strings are constrained within the spin drying basket; the upper rod is pressed downward relative to the lower rod; and when the upper rod is pressed downward, the driving mechanism drives the lower rod to rotate, thereby driving the mop head at the lower end of the lower rod to rotate;

a bottom surface of the spin drying basket is provided with a projection; when the cleaning strings on the mop head are spin-dried, the rotation center of the mop head is in contact with the projection, thereby forming a constraining space between the base plate of the mop head and the spin drying basket; and the cleaning strings are loosely constrained within the constraining space, such that when the mop head rotates, water and dirt are thrown out from the cleaning strings on the mop head; and

when the mop head is placed in the spin drying basket, the mop head is connected in a driving manner to the projection of the spin drying basket, such that the spin drying basket is driven by the rotating mop head to rotate.

Further, a portion of the projection abutting against the mop head forms a rotation center of the spin drying basket.

Further, the portion of the projection abutting against the mop head is basically flush with an upper edge of the spin drying basket.

Further, the spin drying basket is located in a hollow basket holder; and the basket holder is provided on the mop bucket.

Further, a bottom surface of the basket holder is fixed to a vertical positioning shaft; and the projection of the spin drying basket is sleeved on the positioning shaft, allowing the spin drying basket to rotate and the projection of the spin drying basket to be axially positioned.

Further, a sphere is provided between a top end of the positioning shaft and the projection.

Further, the projection of the spin drying basket includes a boss protruding from a center of a bottom of the spin drying basket and a drive shaft sleeve inserted into a center of the boss and fixed to the boss; the drive shaft sleeve is provided with a chamber closed at an upper end and open at a lower end along an axial direction, such that the drive shaft sleeve is rotatably sleeved on an upper end of the positioning shaft; the sphere is located in the chamber of the drive shaft sleeve; and the sphere is connected to the top end of the positioning shaft and abuts against an inner top surface of the drive shaft sleeve.

Further, an inner wall of a lower part of the drive shaft sleeve is provided with a protruding positioning portion; the positioning shaft is provided with an annular positioning groove corresponding to the positioning portion of the drive shaft sleeve; and the positioning portion of the drive shaft sleeve is clamped into the annular positioning groove, allowing the drive shaft sleeve to rotate relative to the positioning shaft.

Further, the annular positioning groove has a width extending along the positioning shaft; and the positioning portion is movable up and down a certain distance along the axial direction of the positioning shaft in the annular positioning groove.

Further, a side of the drive shaft sleeve is provided with an axial passive drive rib; and the passive drive rib is embedded in the boss; and

the back surface of the base plate of the mop head is provided with a driving groove; the driving groove is provided therein with an active drive rib; when the mop head is placed in the spin drying basket, the drive shaft sleeve is inserted into the driving groove; and when the mop head rotates, the active drive rib abuts against the passive drive rib, thereby driving the drive shaft sleeve to rotate.

Further, the spin drying basket is located in a hollow basket holder; and the basket holder is detachably provided on the mop bucket.

Further, the basket holder is hung on an upper end of the mop bucket.

Further, the basket holder is rotatably provided with a handle; and two ends of the handle are rotatably connected to the basket holder.

Further, a downward extending positioning hook is provided at a tail end of a lower side of the handle;

the basket holder is provided with a basket holder brim located below the handle; and the basket holder brim is provided with an upper notch corresponding to the positioning hook;

the mop bucket is provided with a mop bucket brim located below the basket holder brim; and the mop bucket brim is provided with a lower notch corresponding to the upper notch; and

when the basket holder is hung on the mop bucket, the basket holder brim abuts against the mop bucket brim; when the handle is placed flat, the handle rests on the basket holder brim; the positioning hook sequentially passes through the upper notch and the lower notch to hook below the mop bucket brim, thereby positioning the basket holder; and to dissemble the basket holder, the handle is rotated upward to detach the positioning hook from the lower notch and the upper notch.

Further, a top of the basket holder or a top of the spin drying basket is provided with a water retaining cover; and the water retaining cover covers a gap between the basket holder and the spin drying basket.

Further, the mop bucket includes one side provided with a spin drying zone and the other side provided with a cleaning zone; and the spin drying basket is located at an upper part of the spin drying zone.

Further, the spin drying basket is circular; and the projection is located in the center of the bottom of the spin drying basket.

Further, a bottom surface of the cleaning zone of the mop bucket is provided with a support mechanism; when the cleaning strings on the mop head are cleaned with water in the cleaning zone, the rotation center of the mop head correspondingly contacts the support mechanism; when the upper rod is pressed downward, the driving mechanism converts the downward pressing of the upper rod into the rotation of the lower rod; and accordingly, the mop head located at the lower end of the lower rod rotates.

Further, the spin drying zone is communicated with the cleaning zone.

Further, the cleaning strings are provided on a mounting disc; and the mounting disc is detachably provided on the back surface of the base plate.

Further, an outer edge of the mounting disc is provided with accommodating holes;

the cleaning strings are bent at a head to form longer mop-cleaning strings and shorter wipe-cleaning strings; and at a bend of the cleaning strings, the cleaning strings are inserted into the accommodating holes, such that the wipe-cleaning strings extend towards a center of the mounting disc while the mop-cleaning strings droop freely; and

when the cleaning strings on the mop head are spin-dried, the wipe-cleaning strings surrounds the projection while the mop-cleaning strings are loosely constrained within the constraining space.

Further, the upper rod and/or the lower rod include a first rod body and a second rod body; a lower end of the first rod body is provided with a hollow space; and the hollow space forms an opening on an end surface of the lower end of the first rod body;

the second rod body includes a body portion, a joint portion, and an insertion portion; the insertion portion is connected to one end of the body portion through the joint portion; and a diameter of the insertion portion is smaller than a diameter of the body portion;

the insertion portion of the second rod body is inserted into the hollow space of the first rod body through the opening at the lower end of the first rod body, such that the second rod body is connected to the first rod body; and

the first rod body is formed by rolling a metal sheet and welding the metal sheet at a joint; and a weld seam is formed at the joint; and

an edge at the opening of the first rod body rolls outward to form a rolled edge; and a curved surface of the rolled edge of the first rod body abuts against an outer surface of the joint portion of the second rod body.

Further, a tail end of the rolled edge is rolled over a highest endpoint of the rolled edge.

Further, the rolled edge is a circle of rolled edge formed by extending the sheet at the edge of the opening of the first rod body outward; and the circle of rolled edge completely or partially abuts against the joint portion.

Further, the rolled edge is rolled into a ring with a circular or elliptical cross-section.

Further, the joint portion is provided with an inclined contact wall; and the curved surface of the rolled edge abuts against an outer surface of the contact wall.

Further, the contact wall is concave and curved; and alternatively, the outer wall is inclined and flat.

Further, the second rod body is detachably connected to the first rod body.

Further, the hollow space of the first rod body is provided therein with a first connector; and alternatively, a side wall of the hollow space of the first rod body is provided with the first connector;

the insertion portion of the second rod body is fixedly connected to a second connector; and alternatively, the insertion portion of the second rod body is provided with the second connector; and

the second connector is connected to the first connector, such that the second rod body is connected to the first rod body.

Further, the first connector is a screw sleeve with an internal thread; the second connector is a screw head with an external thread; the external thread is adapted to the internal thread; and when the first rod body is connected to the second rod body, the screw head is screwed into the screw sleeve.

Further, the body portion, the joint portion, and the insertion portion of the second rod body are integrated; and/or the second rod body is a metal rod body formed by rolling a sheet and welding the sheet at a joint.

Further, a height of the constraining space is equivalent to a length of the cleaning strings;

alternatively, the height of the constraining space is greater than the length of the cleaning strings; and

alternatively, the height of the constraining space is less than the length of the cleaning strings, and the height of the constraining space is 6/10 to 9/10 of the length of the cleaning strings.

The present disclosure has the following beneficial effects. The bottom surface of the spin drying basket is provided with the projection. When the cleaning strings on the mop head are spin-dried, the rotation center of the mop head is in contact with the projection, thereby forming the constraining space between the base plate of the mop head and the spin drying basket. The cleaning strings are loosely constrained within the constraining space, such that when the mop head rotates, water and dirt are thrown out from the cleaning strings on the mop head.

### BRIEF DESCRIPTION OF THE DRAWINGS

FIG. 1 is a structural diagram of a rotary mop cleaning tool showing that a mop is placed in a spin drying basket according to the present disclosure;

FIG. 2 is a section view of the rotary mop cleaning tool showing that the mop is placed in the spin drying basket according to the present disclosure;

FIG. 3 is schematic diagram of the rotary mop cleaning tool with cleaning strings shown in FIG. 2 removed;

FIG. 4 is a structural diagram of a mop bucket;

FIG. 5 is a structural diagram of the spin drying basket located in a basket holder;

FIG. 6 is a structural diagram of the spin drying basket;

FIG. 7 is a section view of the spin drying basket located in a basket holder;

FIG. 8 is an exploded view of the spin drying basket;

FIG. 9 is a section view of a drive shaft sleeve;

FIG. 10 is an exploded view of the mop bucket;

FIG. 11 is a structural diagram of a handle;

FIG. 12 is a structural diagram of a mop head;

FIG. 13 is a structural diagram of a mounting disc and the cleaning strings;

FIG. 14 is a structural diagram of the mounting disc;

FIG. 15 is a structural diagram of the cleaning strings;

FIG. 16 is a structural diagram of the cleaning strings located on the mounting disc;

FIG. 17 is a structural diagram of a mop rod;

FIG. 18 is an exploded view of the mop rod;

FIG. 19 is an exploded view of the mop rod from another perspective;

FIG. 20 is a section view of a connection point between a first rod body and a second rod body of the mop rod;

FIG. 21 is a detail of A shown in FIG. 20.

FIG. 22 is another schematic diagram of the mop rod;

FIG. 23 is another schematic diagram of the mop rod; and

FIG. 24 is a structural diagram of a back surface of the mop head.

### DETAILED DESCRIPTION OF THE EMBODIMENTS

The present disclosure is further described below with reference to the drawings and specific implementations.

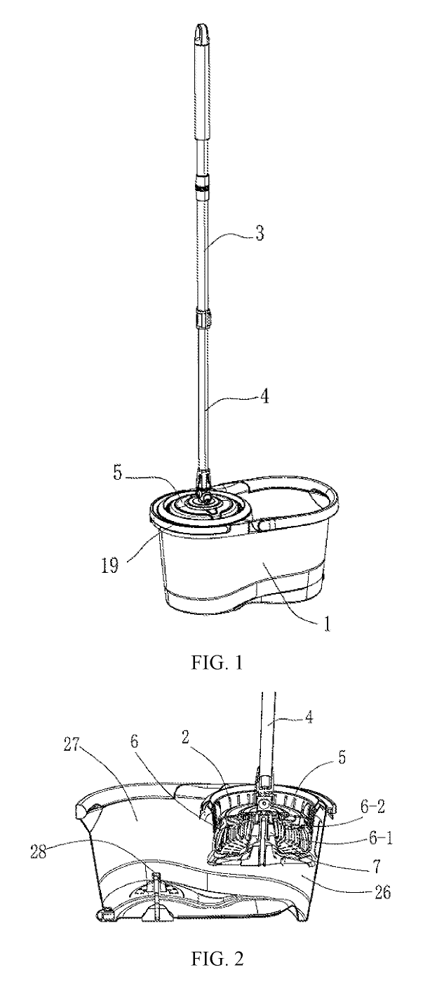

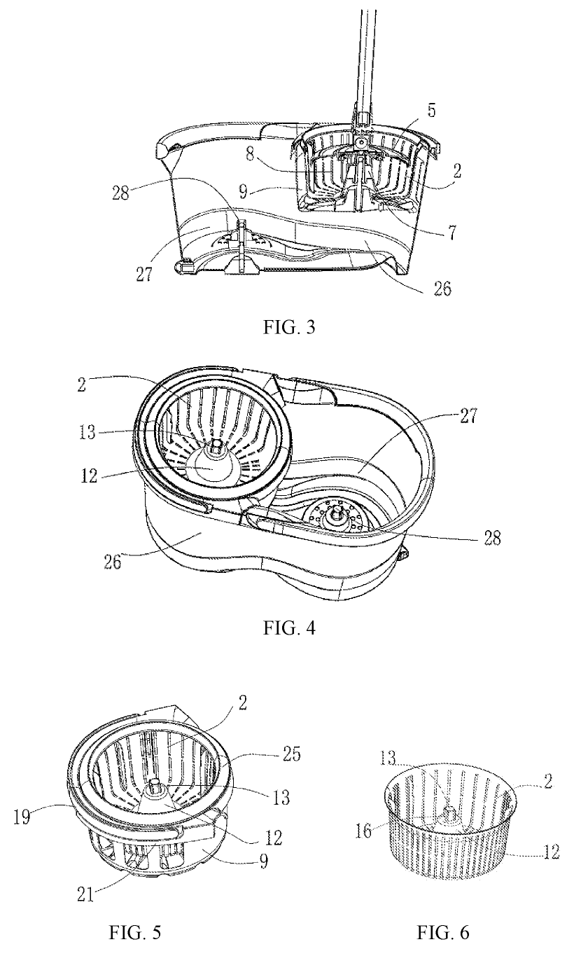

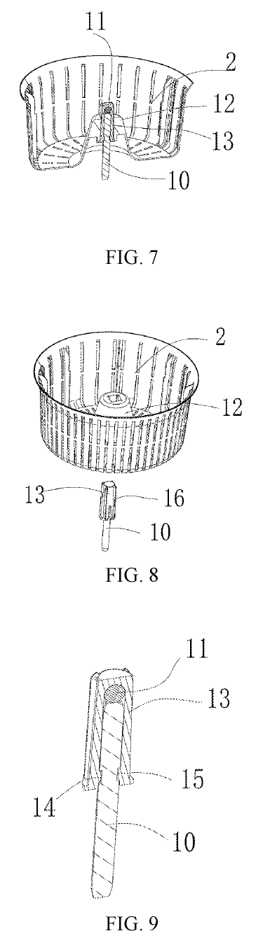

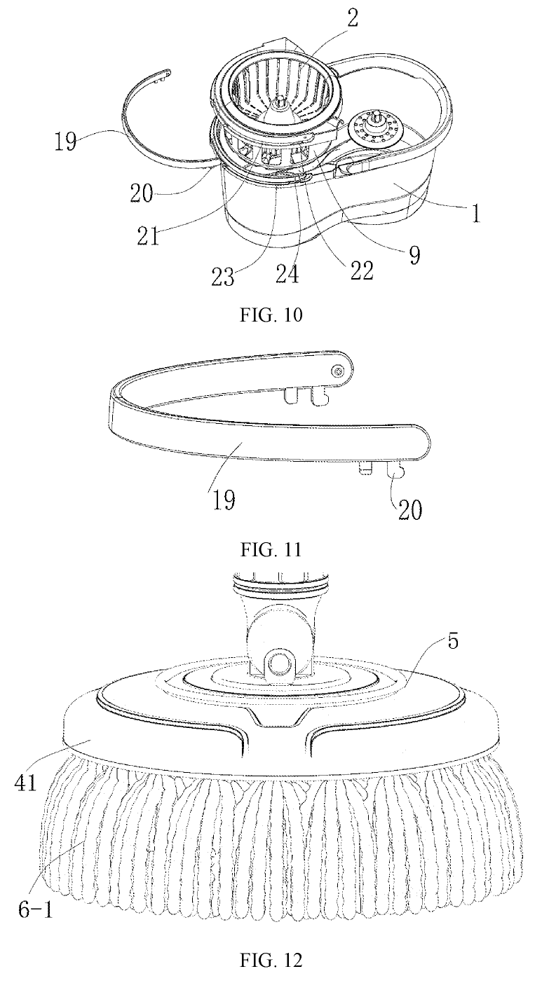

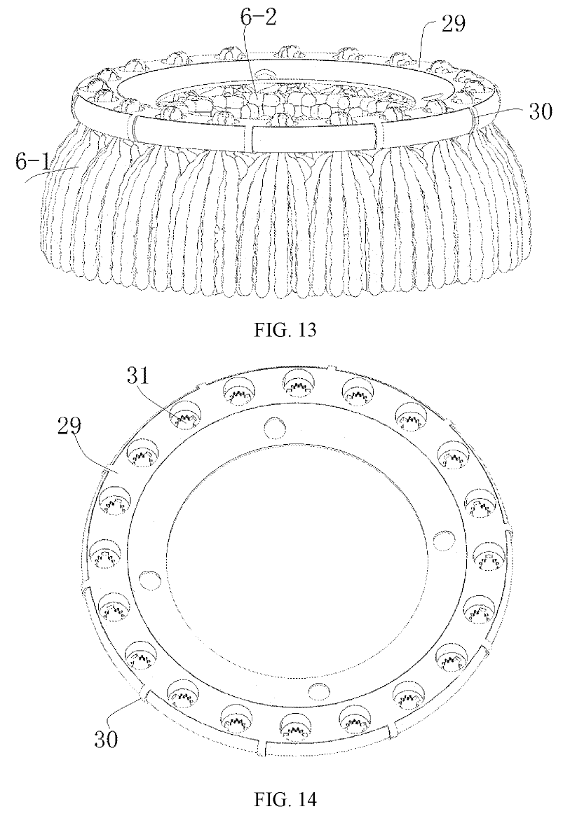

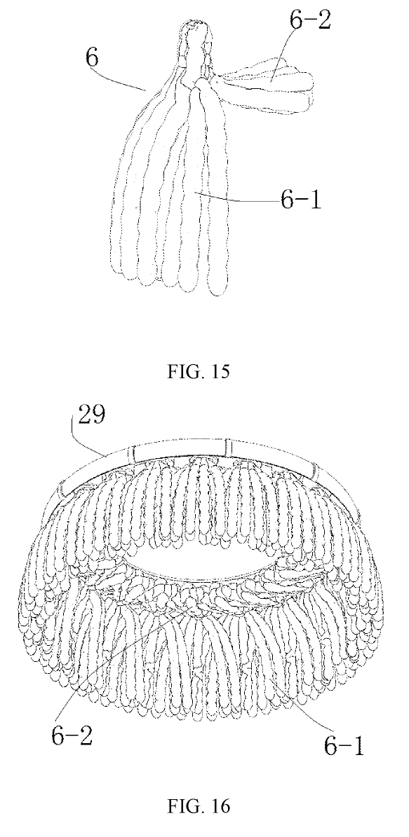

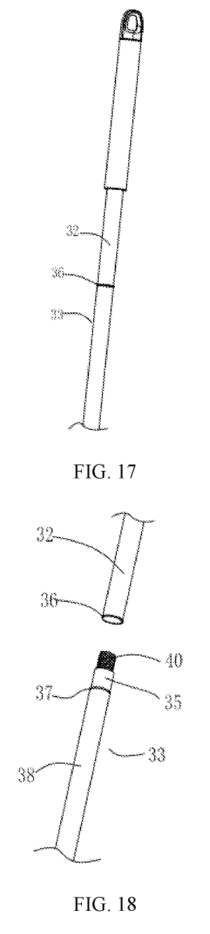

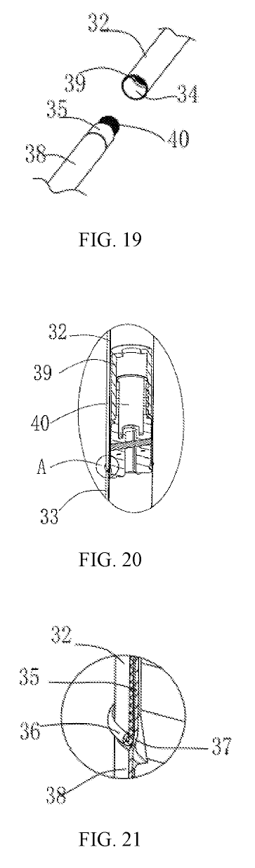

As shown in FIGS. 1 to 24, a rotary mop cleaning tool includes a mop and mop bucket 1. An upper part of the mop bucket 1 is provided with rotatable spin drying basket 2.

The mop includes a mop head, as well as upper rod 3 and lower rod 4 that are joined together. The mop head includes base plate 5 and cleaning strings 6 provided on the base plate 5. The cleaning strings 6 protrude from a back surface of the base plate 5. A lower end of the lower rod 4 is connected to a rotation center of the mop head. A driving mechanism is provided between the upper rod 3 and the lower rod 4.

When the cleaning strings 6 on the mop head are spin-dried, the mop head is placed in the spin drying basket 2, such that the cleaning strings 6 are constrained within the spin drying basket 2. The upper rod 3 is pressed downward relative to the lower rod 4. When the upper rod 3 is pressed downward, the driving mechanism drives the lower rod 4 to rotate, thereby driving the mop head at the lower end of the lower rod 4 to rotate.

The driving mechanism that converts the downward pressing of upper rod 3 into the rotation of the lower rod 4 is a conventional prior art for rotary mop cleaning tools. It can adopt the structure of the driving mechanism in the prior art, such as the structure with a spindle disclosed by EP06724523A, CN201431427Y, CN201505105U, CN101828893A, CN202537437U, and a drive sleeve with a thread in a mop rod disclosed by CN202060728U, CN202568129U, CN204071985U, CN205094344U, CN205799423U, where the drive sleeve cooperates with a drive rod penetrating the mop rod.

A bottom surface of the spin drying basket 2 is provided with projection 7. When the cleaning strings 6 on the mop head are spin-dried, the rotation center of the mop head is in contact with the projection 7, thereby forming constraining space 8 between the base plate 5 of the mop head and the spin drying basket 2. The cleaning strings 6 are loosely constrained within the constraining space 8, such that when the mop head rotates, water and dirt are thrown out from the cleaning strings 6 on the mop head. In order to loosely constrain the cleaning strings 6 within the constraining space 8, a height of the constraining space 8 is equivalent to a length of the cleaning strings 6. Alternatively, the height of the constraining space 8 is greater than the length of the cleaning strings 6. Alternatively, the height of the constraining space 8 is less than the length of the cleaning strings 6, and the height of the constraining space 8 is 6/10 to 9/10 of the length of the cleaning strings 6. The height of constraining space 8 refers to a distance between a bottommost surface of the spin drying basket 2 and the back surface of the base plate 5 of the mop head when the rotation center of the mop head is in contact with the projection 7 of the spin drying basket. The cleaning strings 6 are light and loose, making it hard to measure its length. Therefore, the length of the cleaning strings 6 refers to the length of the cleaning strings 6 when it naturally droops under the action of gravity when absorbing water.

When the mop head is placed in the spin drying basket 2, the mop head is connected in a driving manner to the projection of the spin drying basket 2, such that the spin drying basket 2 is driven by the rotating mop head to rotate. The mop head and the spin drying basket 2 rotate synchronously at high speed, causing the water in the cleaning strings 6 and the dirt adhered to the cleaning strings 6 to be thrown out. In an embodiment, a portion of the projection of the spin drying basket 2 abutting against the mop head forms a rotation center of the spin drying basket 2, ensuring smooth rotation of the spin drying basket 2. In an embodiment, the portion of the projection 7 abutting against the mop head is basically flush with an upper edge of the spin drying basket 2, providing the wide constraining space 8 and allowing the cleaning strings 6 to be fully located in the spin drying basket 2.

In an embodiment, the spin drying basket 2 is located in hollow basket holder 9. The basket holder 9 is provided on the mop bucket 1 for easy mounting of the spin drying basket 2. In the case of the basket holder 9, the spin drying basket 2 and the basket holder 9 can be arranged in the following way. A bottom surface of the basket holder 9 is fixed to vertical positioning shaft 10. The projection 7 of the spin drying basket is sleeved on the positioning shaft 10, allowing the spin drying basket 2 to rotate and the projection 7 of the spin drying basket to be axially positioned. Therefore, the spin drying basket 2 will not detach from the positioning shaft 10 during rotation. In an embodiment, sphere 11 is provided between a top end of the positioning shaft 10 and the projection 7. Due to the sphere 11, the friction between the projection 7 of the spin drying basket and the positioning shaft 10 is extremely small, which is conducive to the rotation of the spin drying basket 2. In addition, the force required to press the upper rod 3 downward is also relatively small, achieving a labor-saving effect. In an embodiment, the specific mounting structure between the positioning shaft 10 and the spin drying basket 2 is as follows. The projection 7 of the spin drying basket includes boss 12 protruding from a center of a bottom of the spin drying basket 2 and drive shaft sleeve 13 inserted into a center of the boss 12 and fixed to the boss 12. The drive shaft sleeve 13 is provided with a chamber along an axial direction. The chamber is closed at an upper end and open at a lower end, such that the drive shaft sleeve 13 is rotatably sleeved on an upper end of the positioning shaft and axially positioned. The sphere 11 is located in the chamber of the drive shaft sleeve 13. The sphere 11 is connected to the top end of the positioning shaft 10 and abuts against an inner top surface of the drive shaft sleeve 13. A specific structure for the axial positioning of the drive shaft sleeve 13 is as follows. An inner wall of a lower part of the drive shaft sleeve 13 is provided with protruding positioning portion 14. The positioning shaft 10 is provided with annular positioning groove 15 corresponding to the positioning portion 14 of the drive shaft sleeve. The positioning portion 14 of the drive shaft sleeve is clamped into the annular positioning groove 15, allowing the drive shaft sleeve 13 to rotate relative to the positioning shaft 10 and achieve axial positioning. In an embodiment, the annular positioning groove 15 has a width extending along the positioning shaft 10. The positioning portion 14 is movable up and down a certain distance along the axial direction of the positioning shaft 10 in the annular positioning groove 15 to smoothly fit the drive shaft sleeve 13 onto the positioning shaft 10. That is, when the drive shaft sleeve 13 is sleeved on the positioning shaft 10, the positioning portion 14 smoothly enters the annular groove 15. In an embodiment, the boss 12 and the drive shaft sleeve 13 are fixed in the following way. A side of the drive shaft sleeve 13 is provided with axial passive drive rib 16. The passive drive rib 16 is embedded in the boss 12. At this point, the specific driving connection between the mop head and the projection 7 of the spin drying basket can be achieved in the following way. The back surface of the base plate 5 of the mop head is provided with driving groove 17. The driving groove 17 is provided therein with active drive rib 18. When the mop head is placed in the spin drying basket 2, the drive shaft sleeve 13 is inserted into the driving groove 17. When the mop head rotates, the active drive rib 18 abuts against the passive drive rib 16, thereby driving the drive shaft sleeve 13 to rotate and causing the spin drying basket 2 to rotate.

In an embodiment, the basket holder 9 is detachably mounted on the mop bucket 1, allowing the basket holder 9 to be detachable for cleaning the interior of the mop bucket 1. The basket holder 9 is detachably connected to the mop bucket in the following way. The basket holder 9 is hung on an upper end of the mop bucket 1. In another specific structure of detachable connection, the basket holder 9 is rotatably provided with handle 19. Two ends of the handle 19 are rotatably connected to the basket holder 9, and the basket holder 9 is detachably connected to the mop bucket 1 through the handle 19. In this way, when the basket holder 9 is removed, the basket holder can be held by the handle 19. In a specific structural form of detachable connection using the handle 19, downward extending positioning hook 20 is provided at a tail end of a lower side of the handle 19. The basket holder 9 is provided with basket holder brim 21 located below the handle 19. The basket holder brim 21 is provided with upper notch 22 corresponding to the positioning hook 20. The mop bucket 1 is provided with mop bucket brim 23 located below the basket holder brim 21. The mop bucket brim 23 is provided with lower notch 24 corresponding to the upper notch 22. When the basket holder 9 is hung on the mop bucket 1, the basket holder brim 21 abuts against the mop bucket brim 23. When the handle 19 is placed flat, the handle 19 rests on the basket holder brim 21. The positioning hook 20 sequentially passes through the upper notch 22 and the lower notch 24 to hook below the mop bucket brim 23, thereby positioning the basket holder 9. To dissemble the basket holder 9, the handle 19 is rotated upward to detach the positioning hook 20 from the lower notch 24 and the upper notch 22.

In an embodiment, a top of the basket holder 9 or a top of the spin drying basket 2 is provided with water retaining cover 25. The water retaining cover 25 covers a gap between the basket holder 9 and the spin drying basket 2. The function of the water retaining cover 25 is to retain the water thrown out during the centrifugal rotation of the mop head.

In an embodiment, one side of the mop bucket 1 is provided with spin drying zone 26, and the other side of the mop bucket 1 is provided with cleaning zone 27. The spin drying basket 2 is located at an upper part of the spin drying zone 26. When the cleaning zone is provided, the cleaning strings 6 can be cleaned in the cleaning zone 27. In an embodiment, the spin drying basket 2 is circular, and the projection 7 is located in the center of the bottom of the spin drying basket 2, which is conducive to the rotation of the spin drying basket 2.

In an embodiment, a bottom surface of the cleaning zone 27 of the mop bucket is provided with support mechanism 28 (such as a support rod). When the cleaning strings 6 on the mop head are cleaned with water in the cleaning zone 27, the rotation center of the mop head correspondingly contacts the support mechanism 28. When the upper rod 3 is pressed downward, the driving mechanism converts the downward pressing of the upper rod 3 into the rotation of the lower rod 4. In this way, the mop head located at the lower end of the lower rod 4 rotates, which facilitates the cleaning of the cleaning strings 6. The spin drying zone 26 is communicated with the cleaning zone 27. That is, the mop bucket 1 is a bucket body with a chamber. The chamber includes one side provided with the spin drying zone 26 and the other side provided with the cleaning zone 27. When the cleaning strings 6 are spin-dried at high speed, the water thrown out falls into the mop bucket. If the spin drying zone 26 and the cleaning zone 27 are separated, the water thrown out by the cleaning strings during spin drying will fall into the spin drying zone 26, and the water level of the spin drying zone will easily rise to the spin drying basket 2, thereby affecting spin drying.

In an embodiment, the cleaning strings 6 are provided on mounting disc 29. The mounting disc 29 is detachably provided on the back surface of the base plate 5, which facilitates the mounting of the cleaning strings 6. The detachable connection between the mounting disc 29 and the base plate 5 can be as follows. An edge of the base plate 5 is provided with flanged ring 41. The mounting disc 29 is embedded in the base plate and in close frictional contact with the flanged ring 41. To increase friction, an outer edge of the mounting disc 29 is provided with convex rib 30. The convex rib 30 further enhances friction to achieve an interference fit effect.

One way to mount the cleaning strings 6 onto the mounting disc 29 is as follows. The outer edge of the mounting disc 29 is provided with accommodating holes 31. The cleaning strings 6 are bent at a head to form longer mop-cleaning strings 6-1 and shorter wipe-cleaning strings 6-2. At a bend of the cleaning strings, the cleaning strings 6 are inserted into the accommodating holes 31, such that the wipe-cleaning strings 6-2 extends toward a center of the mounting disc 29 while the mop-cleaning strings 6-1 droops freely. When the cleaning strings 6 on the mop head are spin-dried, the wipe-cleaning strings 6-2 surround the projection 7 while the mop-cleaning strings 6-1 are loosely constrained within the constraining space 8. The beneficial effects of this mounting method for the cleaning strings are as follows. (1) The mounting of the cleaning strings 6 are relatively simple. In order to firmly fix the cleaning strings 6 to the mounting disc 29 when mounting, teeth can be provided at an edge of the accommodating hole 31. (2) The cleaning strings are inserted into the accommodating holes 31 at the bend of the cleaning strings 6, forming the wipe-cleaning strings 6-2 and the freely drooping mop-cleaning strings 6-1. The mop-cleaning strings 6-1 are longer, and when cleaning the ground, the mop-cleaning strings 6-1 basically disperses outside the base plate 5, thereby mopping the ground through the mop-cleaning strings 6-1. The wipe-cleaning strings 6-2 are located below the base plate 5. When cleaning the ground, the wipe-cleaning strings 6-2 are pressed against a bottom surface by the base plate 5 for wiping. The design achieves simultaneous mopping and wiping, resulting in a better cleaning effect.

In an embodiment, the upper rod and/or the lower rod include first rod body 32 and second rod body 33. Generally speaking, the first rod body 32 and the second rod body 33 are made of a metal material, but they can also be made of a non-metal material. When the first rod body 32 and the second rod body 33 are made of a metal material, in order to facilitate molding and save costs, the first rod body 32 and the second rod body 33 can be molded in the following way. The first rod body 32 and the second rod body 33 each are formed by rolling a metal sheet and welding the metal sheet at a joint, where a weld seam is formed at the joint.

A lower end of the first rod body 32 is provided with hollow space 34. The hollow space 34 forms an opening on an end surface of the lower end of the first rod body 32. When the first rod body 32 is formed by rolling a metal sheet and welding the metal sheet at a joint, naturally, the hollow space 34 and the opening are formed at the lower end of the first rod body 32. The second rod body includes body portion 38, joint portion 37, and insertion portion 35. The insertion portion 35 is connected to one end of the body portion 38 through the joint portion 37. A diameter of the insertion portion 35 is at least smaller than a diameter of the body portion 38. Generally speaking, the body portion 38, the joint portion 37, and the insertion portion 35 of the second rod body are integrated.

The insertion portion of the second rod body 33 is inserted into the hollow space 34 of the first rod body 32 through the opening at the lower end of the first rod body 32, such that the second rod body 33 is connected to the first rod body 32. The sheet at the edge of the opening of the first rod body 32 at least rolls outward from the weld seam to form rolled edge 36. The rolled edge 36 is provided with a curved surface. The curved surface of the rolled edge 36 of the first rod body 32 abuts against an outer surface of the joint portion 37 of the second rod body 33. That is, the first rod body is connected to the second rod body until the curved surface of the rolled edge 36 of the first rod body comes into contact with the outer surface of the joint portion 37 of the second rod body. The so-called rolled edge is formed by the sheet at the edge of the opening of the first rod body, which not only extends outward, but also curls inward in the direction of the first rod body 32.

In the above structure, especially, the first rod body 32 and the second rod body 33 each are formed by rolling a metal sheet and welding the metal sheet at a joint, where a weld seam is formed at the joint. Generally speaking, rods, such as mop rod, broom rod, and dustpan rod, are metal rods. For these household cleaning products, the cost of using seamless metal pipes is too high. The method of forming the rod body by rolling the metal sheet and welding the metal sheet at the joint can save costs. But this type of rod body has a major problem. Due to the fact that the first rod body 32 and the second rod body 33 are welded pipes formed by rolling and welding, the stress concentrates in the weld seam. When in use, there is an external force pressing or acting on the rod body. Under the external force (especially when the mop or broom rod is in use, the rod body is pressed, resulting in a particularly large external force on the rod body), the stress further concentrates at the contact position between the first rod body and the second rod body. Since the side wall at the opening of the first rod body is basically linear, it is hard to effectively disperse the stress. As a result, it is easy to cause a rupture at the end of the weld seam of the first rod body. Once a rupture appears at the end of the weld seam, the weld seam is easily torn apart when an operation continues. In addition, under the external force, the opening of the first rod body is prone to deformation and expansion. Based on these two reasons, the service life of the rod is relatively short, and after a period of use, there will be a large gap at the connection between the first rod body and the second rod body, which will cause loosening.

To solve the problem existing in the prior art, a plastic sleeve is provided between the first rod body and the second rod body. However, due to the soft and easily deformed plastic of the plastic sleeve, the plastic sleeve can only alleviate the damage or deformation problem at the lower end of the first rod body, but cannot effectively solve this problem.

The technical solution of the present disclosure also faces the problem of stress concentration in the weld seam. However, the weld seam at the opening on the lower end of the first rod body is provided with the rolled edge 36 that extends outward. The curved surface of the rolled edge 36 abuts against the joint portion 37, relatively increasing the contact area. Therefore, when there is an external force applied to the rod body, it can effectively disperse the stress and prevent the end of the weld seam at the lower end of the first rod body from being ruptured. The rolled edge 36 that extends outward also enhances the strength of the weld seam, further increasing the difficulty of tearing. In addition, the contact between the curved surface of the rolled edge 36 and the joint surface of the joint portion 37 increases the contact area relatively and increases the friction force. Therefore, the first rod body 32 and the second rod body 33 are easier to lock and less likely to loosen. Based on the above beneficial effects, there is no need to provide the plastic sleeve between the first rod body 32 and the second rod body 33.

In an embodiment, the hollow space of the first rod body 32 is provided therein with a first connector. The insertion portion 35 of the second rod body 33 is fixedly connected to a second connector. The second connector is connected to the first connector, such that the second rod body 33 is connected to the first rod body 32. In order to facilitate the disassembly and assembly of the first rod body 32 and the second rod body 33, the second rod body 33 is detachably connected to the first rod body 32. In a detachable connection method, the first connector includes screw sleeve 39 with an internal thread, and the second connector is specifically screw head 40 with an external thread. The external thread is adapted to the internal thread. When the first rod body 32 is connected to the second rod body 33, the screw head 40 is screwed into the screw sleeve 39. Of course, other methods can also be used for the first connector and the second connector. For example, the first connector is a connecting sleeve with a wedge groove inside, and the second connector is a wedge head with a wedge element adapted to the wedge groove. When the first rod body and the second rod body are connected, the wedge element is inserted into the wedge groove until the outward protrusion comes into contact with a joint surface.

Of course, the first connector can also be formed on a side wall of the hollow space 34 of the first rod body 32. That is, the first connector is formed in the hollow space 34 of the first rod body, rather than a separate component. The second connector can also be formed on the insertion portion 35, rather than a separate component. For example, the first connector is a thread formed on the side wall of the hollow space 34 of the first rod body, and the second connector is a thread formed on the insertion portion 35 and adapted to the thread on the side wall of the hollow space.

In an embodiment, the rolled edge 36 is a circle of rolled edge formed by extending the sheet at the edge of the opening of the first rod body outward. This circle of rolled edge completely or partially abuts against the joint portion. The edge of the opening of the first rod body 32 extends outward as a whole to form the rolled edge 36, making it easy to form the rolled edge 36. In addition, this circle of rolled edge 36 enhances the strength of the opening, making the opening less likely to deform and the weld seam less likely to tear. Of course, multiple rolled edges extending outward can also be formed by the sheet at the edge of the opening of the first rod body 32, and the multiple rolled edges are separated and not connected to each other.

In an embodiment, a tail end of the rolled edge 36 is rolled over a highest endpoint of the rolled edge 36, that is, the tail end of the rolled edge 36 is hidden inside the rolled edge 36, and will not be touched by the operator. The significance of this structure is as follows. In the prior art, the metal sheet at the opening of the first rod body 32 will form a relatively sharp cutting edge, making it easy for the operator to be scratched by the cutting edge. This is also one of the reasons why a plastic sleeve is sometimes provided between the first rod body 32 and the second rod body 33 in the prior art. After the tail end of the rolled edge 36 is rolled over the highest endpoint of the rolled edge, the tail end of the rolled edge 36 is hidden inside the rolled edge 36 and will not be touched by the operator, avoiding the operator from being scratched by the cutting edge. Therefore, there is no need to provide a plastic sleeve between the first rod body 32 and the second rod body 33.

In an embodiment, as shown in FIGS. 20, 21, 22, and 23, the rolled edge 36 is rolled into a ring with a circular or elliptical cross-section. In terms of craftsmanship, compared to other shapes, the ring with a circular or elliptical cross-section formed by rolling the opening at the lower end of the first rod body 32 outward is basically the simplest. In addition, the circular or elliptical ring is not angular, making it easier to disperse stress. Of course, the circular cross-section here refers to a cross-section that is essentially circular, not necessarily an absolute perfect circle. The elliptical cross-section here refers to a cross-section that is essentially elliptical, not necessarily an absolute ellipse.

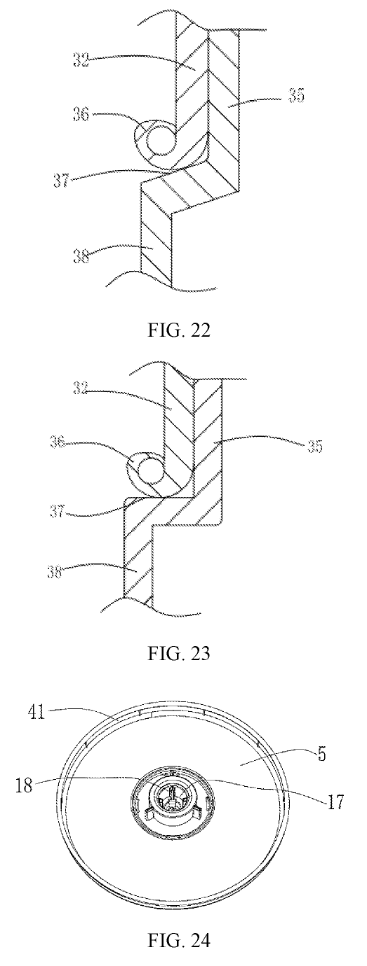

In an embodiment, the joint portion 37 is provided with an inclined contact wall. The curved surface of the rolled edge 36 abuts against the outer surface of the contact wall. The inclined contact wall facilitates the integrated molding of the body portion 38, the joint portion 37, and the insertion portion 35, and increases the contact area between the rolled edge 36 and the contact wall. Preferably, the contact wall is concave and curved. For example, in FIGS. 20 and 21, the rolled edge 36 is a ring with a basically circular cross-section, and the contact wall of the joint portion 37 is concave and curved. The curved surface of the ring-shaped rolled edge forms a large contact area with the concave curved surface. As shown in FIG. 22, the rolled edge 36 is a ring with a basically circular cross-section, and the contact wall of the joint portion 37 is inclined and flat located on an outer wall of the second rod body 33. The curved surface of the ring-shaped rolled edge forms a large contact area with the inclined flat surface.

Of course, the contact wall is not necessarily a slope. As shown in FIG. 22, the rolled edge 36 is a ring with a basically circular cross-section, and the joint portion 37 is a horizontal radial step surface that connects the insertion portion with the rest of the second rod body. The curved surface of the ring-shaped rolled edge forms a large contact area with the horizontal step surface.

In the description of this specification, the description with reference to the terms "an embodiment", "some embodiments", "an example", "a specific example", or "some examples" means that specific features, structures, materials or characteristics described with reference to the embodiment or example are included in at least one embodiment or example of the present disclosure. In this specification, the schematic representations of the above terms do not necessarily refer to the same embodiment or example. In addition, the specific features, structures, materials, or characteristics described may be combined in any suitable manner in any one or more embodiments or examples.

The foregoing illustrates the implementations of the present disclosure. However, the present disclosure is not limited to the aforementioned implementations. Any modifications, equivalent substitutions, improvements, etc. made within the spirit and principle of the present disclosure should be included in the protection scope of the present disclosure.

1. A rotary mop cleaning tool, comprising a mop and a mop bucket, wherein
an upper part of the mop bucket is provided with a spin drying basket configured to be rotatable;
the mop comprises a mop head, an upper rod and a lower rod, wherein the upper rod and the lower rod are joined together; the mop head comprises a base plate and cleaning strings provided on the base plate; the cleaning strings protrude from a back surface of the base plate; a lower end of the lower rod is connected to a rotation center of the mop head; and a driving mechanism is provided between the upper rod and the lower rod;
when the cleaning strings on the mop head are spin-dried, the mop head is placed in the spin drying basket, and the cleaning strings are constrained within the spin drying basket; the upper rod is pressed downward relative to the lower rod; and when the upper rod is pressed downward, the driving mechanism drives the lower rod to rotate, thereby driving the mop head at the lower end of the lower rod to rotate;
a bottom surface of the spin drying basket is provided with a projection; when the cleaning strings on the mop head are spin-dried, the rotation center of the mop head is in contact with the projection, thereby forming a constraining space between the base plate of the mop head and the spin drying basket; the cleaning strings are loosely constrained within the constraining space, and then when the mop head rotates, water and dirt are thrown out from the cleaning strings on the mop head; and a portion of the projection abutting against the mop head forms a rotation center of the spin drying basket; and
when the mop head is placed in the spin drying basket, the mop head is connected to the projection of the spin drying basket in a driving manner that the spin drying basket is driven to rotate by a rotation of the mop head.

2. The rotary mop cleaning tool according to claim 1, wherein the portion of the projection abutting against the mop head is basically flush with an upper edge of the spin drying basket.

3. The rotary mop cleaning tool according to claim 1, wherein the spin drying basket is located in a basket holder; and the basket holder is hollow and provided on the mop bucket.

4. The rotary mop cleaning tool according to claim 3, wherein a bottom surface of the basket holder is fixed to a positioning shaft configured to be vertical; and the projection of the spin drying basket is sleeved on the positioning shaft, allowing the spin drying basket to rotate and axially positioning the projection of the spin drying basket.

5. The rotary mop cleaning tool according to claim 4, wherein a sphere is provided between a top end of the positioning shaft and the projection.

6. The rotary mop cleaning tool according to claim 5, wherein the projection of the spin drying basket comprises a boss protruding from a center of a bottom of the spin drying basket and a drive shaft sleeve inserted into a center of the boss and fixed to the boss; the drive shaft sleeve is provided with a chamber closed at an upper end and open at a lower end along an axial direction, and the drive shaft sleeve is rotatably sleeved on an upper end of the positioning shaft and axially positioned; the sphere is located in the chamber of the drive shaft sleeve; and the sphere is connected to the top end of the positioning shaft and abuts against an inner top surface of the drive shaft sleeve.

7. The rotary mop cleaning tool according to claim 6, wherein an inner wall of a lower part of the drive shaft sleeve is provided with a protruding positioning portion; the positioning shaft is provided with an annular positioning groove corresponding to the protruding positioning portion of the drive shaft sleeve; and the protruding positioning portion of the drive shaft sleeve is clamped into the annular positioning groove, allowing the drive shaft sleeve to rotate relative to the positioning shaft.

8. The rotary mop cleaning tool according to claim 6, wherein a side of the drive shaft sleeve is provided with a passive drive rib configured to be axial; and the passive drive rib is embedded in the boss; and
the back surface of the base plate of the mop head is provided with a driving groove; an active drive rib is provided in the driving groove; when the mop head is placed in the spin drying basket, the drive shaft sleeve is inserted into the driving groove; and when the mop head rotates, the active drive rib abuts against the passive drive rib, thereby driving the drive shaft sleeve to rotate.

9. The rotary mop cleaning tool according to claim 1, wherein the spin drying basket is located in a basket holder; the basket holder is hollow and detachably provided on the mop bucket; and the basket holder is hung on an upper end of the mop bucket.

10. The rotary mop cleaning tool according to claim 9, wherein the basket holder is rotatably provided with a handle; and two ends of the handle are rotatably connected to the basket holder;
a positioning hook extends downward and is provided at a tail end of a lower side of the handle;
the basket holder is provided with a basket holder brim located below the handle; and the basket holder brim is provided with an upper notch corresponding to the positioning hook;
the mop bucket is provided with a mop bucket brim located below the basket holder brim; and the mop bucket brim is provided with a lower notch corresponding to the upper notch; and
when the basket holder is hung on the mop bucket, the basket holder brim abuts against the mop bucket brim; when the handle is placed flat, the handle rests on the basket holder brim; the positioning hook sequentially passes through the upper notch and the lower notch to hook below the mop bucket brim, thereby positioning the basket holder; and when the basket holder is unhooked, the handle is rotated upward to detach the positioning hook from the lower notch and the upper notch.

11. The rotary mop cleaning tool according to claim 9, wherein a top of the basket holder or a top of the spin drying basket is provided with a water retaining cover; and the water retaining cover covers a gap between the basket holder and the spin drying basket.

12. The rotary mop cleaning tool according to claim 1, wherein the cleaning strings are provided on a mounting disc; and the mounting disc is detachably provided on the back surface of the base plate;
an outer edge of the mounting disc is provided with accommodating holes;
the cleaning strings are bent at a head to form longer mop-cleaning strings and shorter wipe-cleaning strings; and at a bend of the cleaning strings, the cleaning strings are inserted into the accommodating holes, and the wipe-cleaning strings extend towards a center of the mounting disc while the mop-cleaning strings droops freely; and
when the cleaning strings on the mop head are spin-dried, the wipe-cleaning strings surround the projection while the mop-cleaning strings are loosely constrained within the constraining space.

13. The rotary mop cleaning tool according to claim 1, wherein the upper rod and/or the lower rod comprise a first rod body and a second rod body; a lower end of the first rod body is provided with a hollow space; and the hollow space forms an opening on an end surface of the lower end of the first rod body;
the second rod body comprises a body portion, a joint portion, and an insertion portion; the insertion portion is connected to one end of the body portion through the joint portion; and a diameter of the insertion portion is smaller than a diameter of the body portion;
the insertion portion of the second rod body is inserted into the hollow space of the first rod body through the opening at the lower end of the first rod body, thereby connecting the second rod body to the first rod body; and
the first rod body is formed by rolling a metal sheet and welding the metal sheet at a joint; and a weld seam is formed at the joint; and
an edge at the opening of the first rod body rolls outward to form a rolled edge; the rolled edge is provided with a curved surface; the rolled edge is rolled into a ring with a circular or elliptical cross-section; and the rolled edge completely or partially abuts against the joint portion.

14. The rotary mop cleaning tool according to claim 13, wherein a tail end of the rolled edge is rolled over a highest endpoint of the rolled edge.

15. The rotary mop cleaning tool according to claim 13, wherein the joint portion is provided with a contact wall configured to be inclined; and the curved surface of the rolled edge abuts against an outer surface of the contact wall.

16. The rotary mop cleaning tool according to claim 15, wherein the contact wall is concave and curved; and alternatively, the contact wall is inclined and flat.

17. The rotary mop cleaning tool according to claim 13, wherein a first connector is provided in the hollow space of the first rod body; and alternatively, a side wall of the hollow space of the first rod body is provided with the first connector;
the insertion portion of the second rod body is fixedly connected to a second connector; and alternatively, the insertion portion of the second rod body is provided with the second connector; and
the second connector is connected to the first connector, thereby connecting the second rod body to the first rod body.

18. The rotary mop cleaning tool according to claim 17, wherein the first connector is a screw sleeve with an internal thread; the second connector is a screw head with an external thread; the external thread is adapted to the internal thread; and when the first rod body is connected to the second rod body, the screw head is screwed into the screw sleeve.

19. The rotary mop cleaning tool according to claim 13, wherein the body portion, the joint portion, and the insertion portion of the second rod body are integrated as a whole; and/or
the second rod body is a metal rod body formed by rolling a sheet and welding the sheet at a joint.

20. The rotary mop cleaning tool according to claim 1, wherein a height of the constraining space is equivalent to a length of the cleaning strings;
alternatively, the height of the constraining space is greater than the length of the cleaning strings; and
alternatively, the height of the constraining space is less than the length of the cleaning strings, and the height of the constraining space is 6/10 to 9/10 of the length of the cleaning strings.
